(19) United States
(12) Patent Application Publication
(10) Pub. No.: US 2022/0100478 A1
(43) Pub. Date: Mar. 31, 2022

(54) CATALOG CREATION ASSISTANCE SYSTEM, CATALOG CREATION ASSISTANCE METHOD, AND PROGRAM

(71) Applicant: Nippon Telegraph and Telephone Corporation, Tokyo (JP)

(72) Inventors: Kensuke Takahashi, Musashino-shi, Tokyo (JP); Ryota Katayanagi, Musashino-shi, Tokyo (JP); Nobuo Onai, Musashino-shi, Tokyo (JP); Miwaka OTANI, Musashino-shi, Tokyo (JP)

(21) Appl. No.: 17/422,046

(22) PCT Filed: Dec. 27, 2019
(86) PCT No.: PCT/JP2019/051602

§ 371 Date: Jul. 9, 2021

(30) Foreign Application Priority Data
Jan. 16, 2019 (JP) 2019-005140

(51) Int. Cl. G06F 8/38; G06F 9/451; G06F 9/54

(52) U.S. Cl. CPC G06F 8/38; G06F 3/0484; G06F 9/541; G06F 9/451

(57) ABSTRACT

A catalog creation support system, catalog creation support method, and program that allow a catalog creator to intuitively create a catalog using a GUI are proposed. The catalog creation support system is a system for supporting catalog creation used in an orchestrator and includes a GUI generation device (30) configured to generate a GUI, and a catalog creation device (40) configured to create a catalog, wherein a catalog definition file (F1) in which definition information of the catalog is described is read and a service-independent catalog information abstraction model is constructed.

### TECHNICAL FIELD

The present invention relates to a catalog creation support system, a catalog creation support method, and a program that support catalog creation that is used in an orchestrator.

### BACKGROUND ART

In recent years, a method of intuitively creating a catalog using a GUI has become common (for example, OpenStack Heat Dashboard or AWS Cloud Formation Designer). Further, an orchestrator technology that defines a service specification or a resource specification in a catalog for automatic construction is well known (for example, Non Patent Literature 1). Further, a framework for generating a GUI based on catalog definition information is known (for example, Non Patent Literature 2).

### CITATION LIST

### Non Patent Literature

Non Patent Literature 1: Architecture that makes service cooperation between a plurality of operators flexible, Takahashi et al., Institute of Electronics, Information and Communication Engineers Society Conference, B-14-8, 2017
Non Patent Literature 2: Proposal of GUI generation framework for catalog creation support for orchestrator, B-14-4, 2018

### SUMMARY OF THE INVENTION

### Technical Problem

However, in OpenStack Heat Dashboard or AWS Cloud Formation Designer, a servicer who develops each catalog creates a GUI independently. It is necessary to develop a GUI for each catalog, and a scheme for facilitating a GUI development method is not mentioned.

Further, an orchestrator of Non Patent Literature 1 has a catalog-driven architecture, and describes a cooperation method when automatic construction is performed by linking a service specification for construction in each service or a plurality of services to the catalog to realize automation, but a scheme for easily creating a catalog is not mentioned. Because a catalog used in the orchestrator differs for each target service and also for each API that is an operation target, it is thought that a wide variety of catalogs will become necessary when various automations are realized in the orchestrator in the future, and an invention for easily creating the catalogs is necessary.

Further, Non Patent Literature 2 describes a framework for generating a GUI from definition information of a catalog, but a specific method of defining a catalog, a scheme of creating a catalog based on information input to a GUI, or a scheme of cooperating with an orchestrator is not described.

In view of these situations, allowing a catalog creator to intuitively create a catalog using a GUI is necessary for reduction of skill required for an operation of catalog creation or the creation that is essential for use of the orchestrator. However, when a GUI and a catalog creation function are developed each time the number of catalog types increases, there is a problem that it is necessary to go through a design/development/verification cycle of a development functional unit each time, and a speed of service addition is impaired.

An object of the present invention is to provide a catalog creation support system, a catalog creation support method, and a program that allow a catalog creator to intuitively create a catalog using a GUI.

### Means for Solving the Problem

In order to achieve the above object, an invention according to a first aspect is a catalog creation support system for supporting catalog creation used in an orchestrator, the catalog creation support system including: a GUI generation device configured to generate a GUI; and a catalog creation device configured to create a catalog, wherein a catalog definition file in which definition information of the catalog is described is read and a service-independent catalog information abstraction model is constructed.

An invention according to a second aspect is the invention according to the first aspect, wherein a GUI including a component pane, an editor pane, and a parameter input pane is generated.

An invention according to a third aspect is the invention according to the first or second aspect, wherein a template that is independent of a service type of the catalog is defined, and an interface is abstracted so that variables described in the template are treated as “array value of basic information” or “array value of component information” together with a catalog definition on a GUI.

An invention according to a fourth aspect is the invention according to any one of the first to third aspects, wherein content of the catalog is abstracted in a service-independent manner as a general-purpose interface.

An invention according to a fifth aspect is the invention according to any one of the first to fourth aspects, wherein an output catalog is linked with the orchestrator by an API.

An invention according to a sixth aspect is a catalog creation support method for supporting catalog creation used in an orchestrator, the catalog creation support method including: generating, at a GUI generation device, a GUI; and creating, at a catalog creation device, a catalog, wherein a catalog definition file in which definition information of the catalog is described is read and a service-independent catalog information abstraction model is constructed.

An invention according to a seventh aspect is a program for causing a computer to function as the catalog creation support system according to any one of the first to fifth aspects.

### Effects of the Invention

According to the present invention, it is possible to provide a catalog creation support system, a catalog creation support method, and a program that allow a catalog creator to intuitively create a catalog using a GUI.

### BRIEF DESCRIPTION OF DRAWINGS

FIG. 1 is a diagram illustrating an example of a catalog definition in an embodiment of the present invention.

FIG. 2 is a diagram illustrating a GUI configuration independent of a catalog configuration in the embodiment of the present invention.

FIG. 3 is a diagram illustrating an example of a template in the embodiment of the present invention.

FIG. 4 is a diagram illustrating an example of an abstract template in the embodiment of the present invention.

FIG. 5 is a functional block diagram of a catalog creation support system in the embodiment of the present invention.

FIG. 6 is a diagram illustrating an example of a business model of B2B2X.

FIG. 7 is a diagram illustrating characteristics of a GUI in the embodiment of the present invention.

FIG. 8 is a diagram illustrating a catalog definition file and a GUI in the embodiment of the present invention.

FIG. 9 is a diagram illustrating an IF definition method in the embodiment of the present invention.

FIG. 10 is a diagram illustrating an IF definition method in the embodiment of the present invention.

FIG. 11 is a diagram illustrating a method of generalizing a catalog creation functional unit in the embodiment of the present invention.

FIG. 12 is a diagram illustrating a method of generalizing a catalog creation functional unit in the embodiment of the present invention.

FIG. 13 is a diagram illustrating a setting of an other-system cooperative functional unit in the embodiment of the present invention.

FIG. 14 is a sequence diagram of the catalog creation support system in the embodiment of the present invention.

FIG. 15 is a diagram illustrating a setting example of catalog information in the embodiment of the present invention.

FIG. 16 is a diagram illustrating a setting example of component information in the embodiment of the present invention.

FIG. 17 is a diagram illustrating a setting example of a component information list in the embodiment of the present invention.

FIG. 18 is a diagram illustrating a setting example of component information in the embodiment of the present invention.

FIG. 19 is a diagram illustrating a setting example of component information in the embodiment of the present invention.

FIG. 20 is a diagram illustrating a setting example of component information in the embodiment of the present invention.

FIG. 21 is a diagram illustrating a setting example of a connection destination information list in the embodiment of the present invention.

FIG. 22 is a diagram illustrating a setting example of a parameter information list in the embodiment of the present invention.

FIG. 23 is a diagram illustrating a setting example of a selection candidate list in the embodiment of the present invention.

FIG. 24 is a diagram illustrating a setting example of a catalog definition in the embodiment of the present invention.

FIG. 25 is a diagram illustrating a setting example of a catalog definition in the embodiment of the present invention.

FIG. 26 is a diagram illustrating a setting example of a catalog definition in the embodiment of the present invention.

FIG. 27 is a diagram illustrating a setting example of a component definition in the embodiment of the present invention.

### DESCRIPTION OF EMBODIMENTS

Hereinafter, embodiments of the present invention will be described with reference to the drawings. In description of the drawings below, the same or similar component are designated by the same or similar reference signs.

Overview

Problems of the related art can be classified into a problem (hereinafter referred to as problem A) caused by describing a catalog through manual input, such as (1) induction of a syntax error due to manual input and (2) knowledge about attribute/value values, and a problem (hereinafter referred to as problem B) caused by describing a machine-readable catalog through manual input, such as (3) complexity of a correspondence relationship with a described configuration and (4) solution to consistency between catalogs configured of a plurality of files.

Here, in order to solve problem B, a scheme for allowing a catalog to be intuitively created using a GUI is adopted. For example, in Heat that is an orchestrator of OpenStack, a function such as OpenStack Heat Dashboard for creating a catalog with a GUI, and a function such as CloudFormation that is the same as in Amazon Web Services (AWS)™ are provided. However, these are GUIs specialized for respective services, and in the case of an orchestrator that causes a plurality of services to be linked, when a GUI for catalog creation is developed each time a service is added, there is a new problem that a speed of the addition of the service is impaired.

Thus, examples of a requirement of a catalog creation support framework proposed by the present inventors include establishment of a method of configuring a GUI independent of a catalog configuration for solving problem B, and establishment of a catalog output method using a value input to a GUI for solving problem A.

In order to solve such a problem, the present invention proposes a catalog creation support framework based on a catalog definition. Examples of characteristics of the proposed method may include two points including the scheme for configuring a GUI independent of a catalog configuration and generalization in catalog output using a GUI input value and a template.

It can be seen that content described in the catalog is classified into three groups including (1) basic information such as an ID, a catalog description, and a version, (2) connection information of components included in the catalog (for example, in a catalog representing a VNF configuration, information on an NIC, Volume, and Flavour connected to the VM), and (3) parameters (for example, volume capacity) for each component.

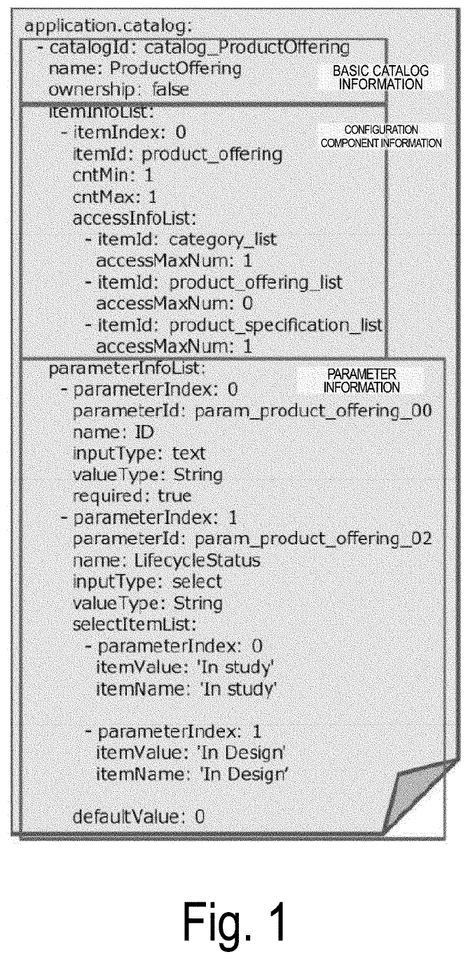

Thus, regarding the GUI configuration scheme, a scheme that defines elements necessary for catalog creation as three elements including “configuration component,” “relationship between components,” and “parameter setting” and is independent of a catalog configuration is provided (FIG. 1). It is possible to generate a GUI without depending on the catalog configuration by decomposing description content of the catalog to be created into configuration components, relationships between components, and parameter settings and creating a definition file. An example of the catalog definition file is illustrated in FIG. 2. As described above, three types of information constituting the catalog are described. Further, when values of “name: LifecycleStatus” and “selectItemList” are described as in parameterindex: 1 of this catalog definition file, a candidate value can be selected from a pull-down menu on the GUI, and an Attribute/Value value necessary for the catalog appears on the GUI, and thus it is possible to solve problem A that occurs when creation is performed by manual input.

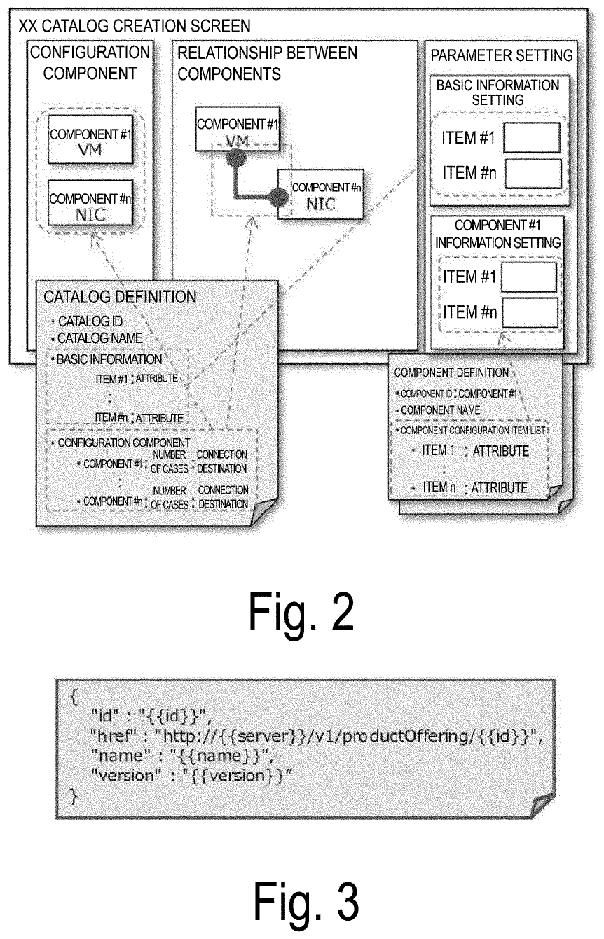

A catalog output scheme using a template is generally used as a scheme for solving the above-described problem A. An example of a simple template is illustrated in FIG. 3 (this template treats a part surrounded by “{{ }}” as a variable).

By creating a catalog to be output as a template in this way, a catalog creator can focus only on an input of a value and can reduce an operation such as induction of a syntax error or an input of the same value to a plurality of locations (in FIG. 3, the catalog creator can input the same value for both “id” and “href” by inputting only one value of “id”).

However, when a catalog-dependent value (for example, “id” or “name”) is expected as an input value as illustrated in FIG. 3 in a template creation method, an interface portion with the GUI input value described above depends on the catalog. Thus, in the catalog creation support framework proposed in the present invention, an interface is abstracted so that variables described in the template are treated as “array value of basic information” or “array value of component information” together with the catalog definition on a GUI.

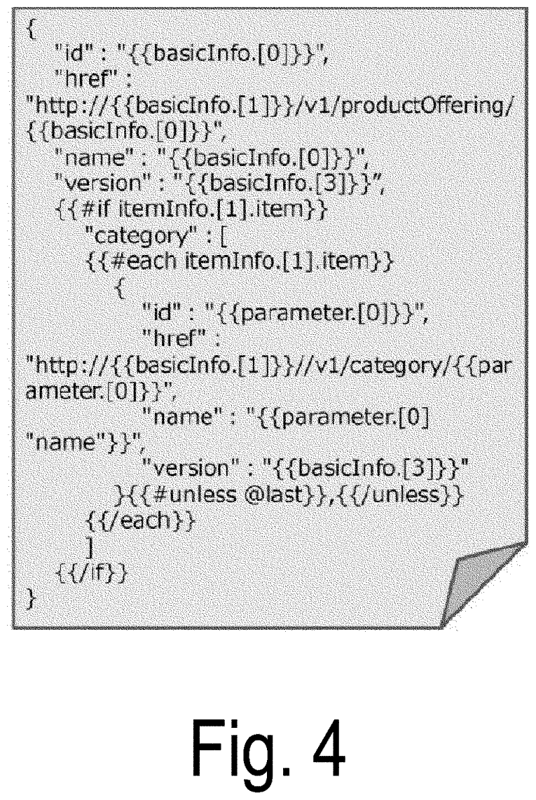

FIG. 4 illustrates an example of a template for reading an abstracted interface. It can be seen that a difference between FIG. 4 and FIG. 3 is that a variable part includes “basicInfo” indicating an array of basic information, “itemiInfo” indicating an array of component information, and “parameter” indicating a parameter in the component information. This enables output that is independent of the catalog configuration.

### EMBODIMENTS

Hereinafter, embodiments of the present invention will be described in more detail.

System Configuration

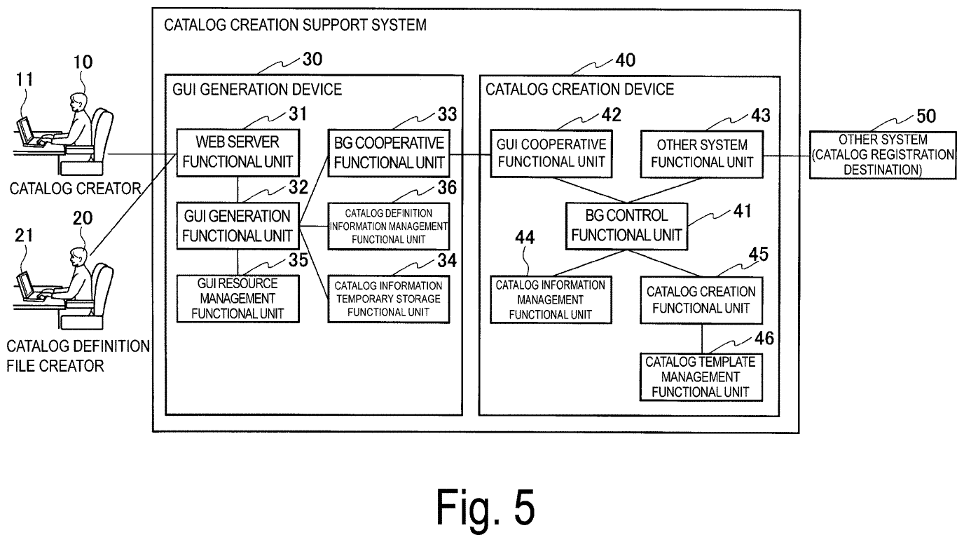

FIG. 5 is a functional block diagram of a catalog creation support system in the embodiment of the present invention. As illustrated in FIG. 5, the catalog creation support system is a system that supports catalog creation that is used in an orchestrator, and includes a GUI generation device 30 and a catalog creation device 40. A catalog creator 10 and a catalog definition file creator 20 can communicate with the catalog creation support system using PCs 11 and 21 in which a browser is mounted. The catalog creation support system is communicatively connected to another system (orchestrator) 50 that is a catalog registration destination.

The GUI generation device 30 is a device that generates a GUI, and functionally includes a web server functional unit 31, a GUI generation functional unit 32, a BG cooperative functional unit 33, a catalog information temporary storage functional unit 34, a GUI resource management functional unit 35, and a catalog definition information management functional unit 36. The web server functional unit 31 provides a GUI function for an HTTP request from the browser. The GUI generation functional unit 32 performs execution control on each request from the browser. The BG cooperative functional unit 33 provides a function of storing catalog information in background (BG) and acquiring information from another system 50. The catalog information temporary storage functional unit 34 provides a function of storing catalog information requested to be stored from the browser or a function for reference to the catalog information at the time of creating a catalog. The GUI resource management functional unit 35 provides a management function for each image displayed in the GUI. The catalog definition information management functional unit 36 provides a registration and reference function for catalog definition information for displaying a catalog creation screen.

The catalog creation device 40 is a device that creates a catalog (a device that provides a BG function), and functionally includes a BG control functional unit 41, a GUI cooperative functional unit 42, an other-system cooperative functional unit 43, a catalog information management functional unit 44, a catalog creation functional unit 45, and a catalog template management functional unit 46. The BG control functional unit 41 performs execution control on each request from the GUI. The GUI cooperative functional unit 42 receives a request for storage of catalog information from the GUI and registration in the other system 50. The other-system cooperative functional unit 43 performs a process of registering, updating, and deleting a catalog in the other system 50, and acquiring the catalog information. The catalog information management functional unit 44 provides a function of storing catalog information requested to be stored from the GUI and a function for referencing catalog information at the time of catalog creation. The catalog creation functional unit 45 creates a catalog requested from the other system 50 based on the stored catalog template information. The catalog template management functional unit 46 provides a function of storing catalog template information or a reference function from the catalog creation functional unit 45.

Utility and Target

According to the catalog creation support system in the embodiment of the present invention, it is possible to read a catalog definition file and a catalog template in which definition information of a catalog to be created is described, to support the catalog creator 10. Thus, utility obtained from the present system is as follows depending on a role of a person who uses the present system.

That is, for the catalog creator 10, it is possible to intuitively create a catalog with the GUI instead of creating the catalog with plain text. On the other hand, for the catalog definition file creator 20, it is not necessary to develop a program for the catalog creation support system for each catalog, and it is possible to generate the catalog creation support system by simply creating a catalog definition file/catalog template. An example of a prerequisite for this utility can include a catalog definition file creation operation being less than program development.

Catalog Creator and Catalog Definition File Creator

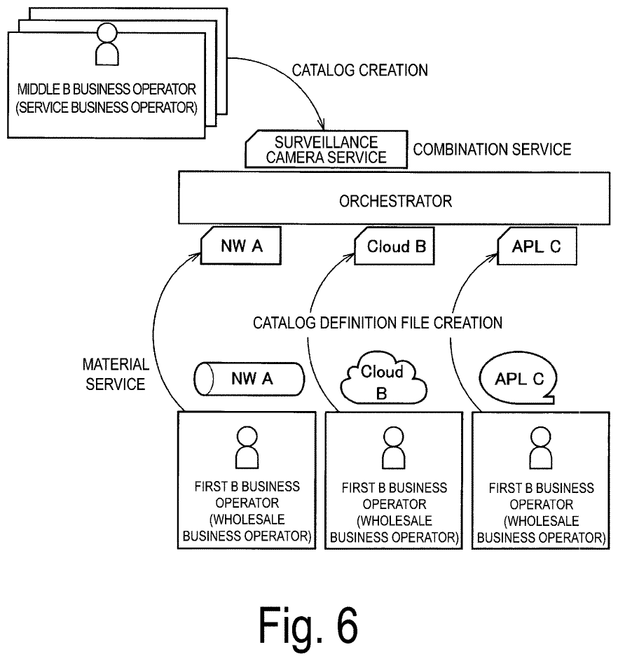

FIG. 6 illustrates an example of a business model of Business To Business To X (B2B2X). The orchestrator encourages a middle B operator who has an idea of starting a new cooperative service to utilize a wholesale service as a material service instead of creating everything from scratch, and drastically improves a speed of service development of the middle-B operators. Technically, a specification of a wholesale service in a market is defined as a “catalog” and a “cooperation catalog” in which catalogs of a plurality of wholesale services in the market are combined is created, for definition of a specification of a cooperative service (combination service). This is aimed at catalog-driven and highly versatile multi-service cooperation execution.

The catalog definition file creator 20 is a person who has a role of creating a catalog for making it possible to control a material service provided by the catalog definition file creator 20 using an orchestrator. In FIG. 6, a first B operator (wholesale operator) corresponds to the catalog definition file creator 20.

The catalog creator 10 is a person who has a role of creating a catalog of “combination service” with which a material service registered in the orchestrator has been combined. In FIG. 6, the middle B operator (service operator) corresponds to the catalog creator 10.

The catalog creation support system in the embodiment of the present invention is applied between the first B operator, the middle B operator, and the orchestrator in FIG. 6. According to the present system, it is possible to read the catalog definition file from the first B operator (the catalog definition file creator 20) and support the middle B operator (the catalog creator 10).

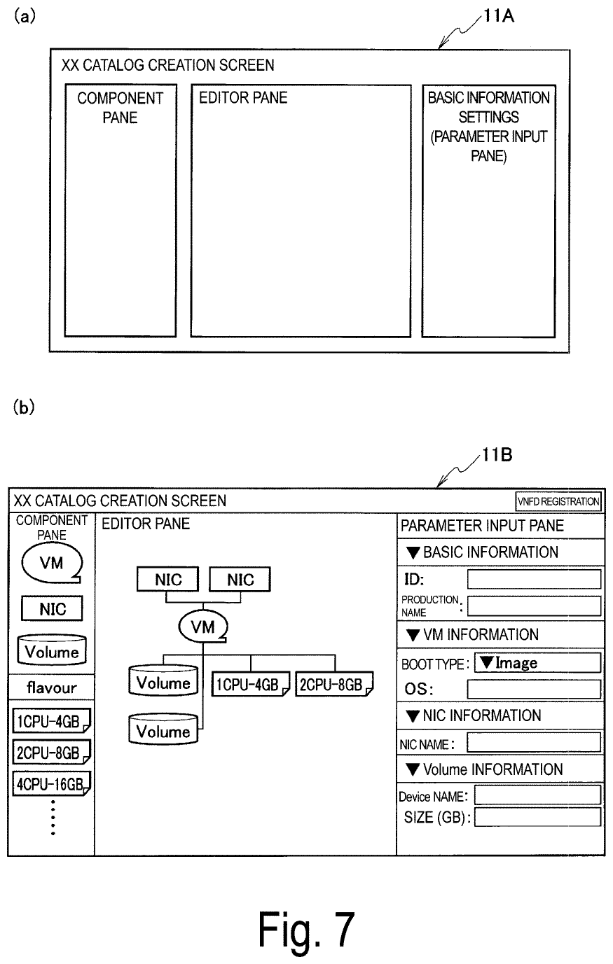

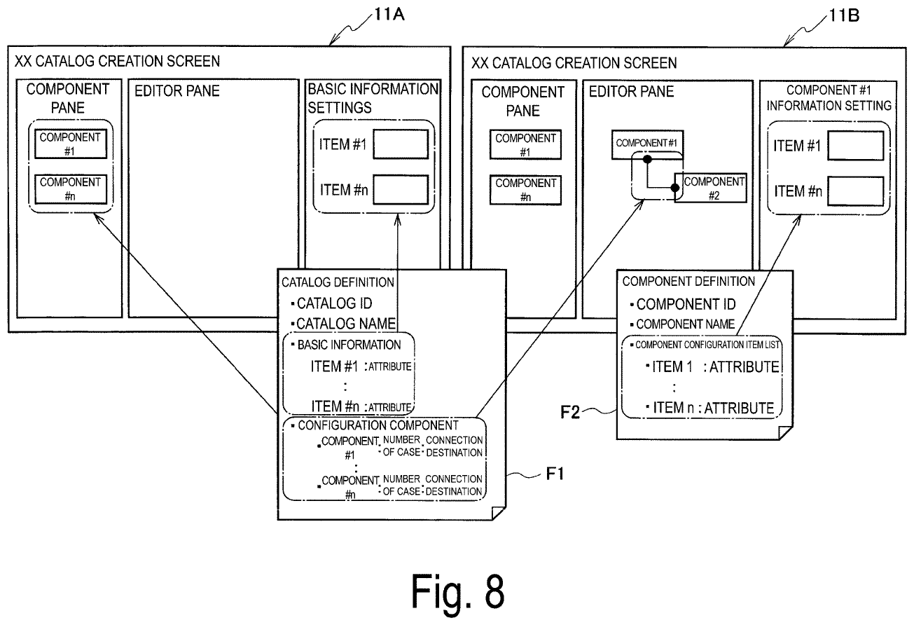

General-Purpose GUI Configuration Method Not Depending on Content of Catalog FIG. 7 is a diagram illustrating features of the GUI in the embodiment of the present invention, and illustrates catalog creation screens 11A and 11B displayed on a PC 11 of the catalog creator 10. FIG. 7(a) illustrates an example in which a framework of a basic GUI is read, and FIG. 7(b) illustrates an example in which the catalog definition file is read.

First, as illustrated in FIG. 7(a), a GUI of a catalog creation screen 11A includes three panes including a “component pane,” an “editor pane,” and a “parameter input pane (basic information settings).” In the component pane, elements required to create a catalog are defined, and can be arranged by dragging and dropping them in the editor pane. In the parameter input pane, information necessary for the catalog can be input. In the parameter input pane, there are two types of information: basic information that can be input when a component is not selected, and component information that can be input by selecting a component.

Here, when the catalog definition file is read, a component displayed in each pane or constraint conditions in the editor pane are automatically generated on a catalog creation screen 11B, as illustrated in FIG. 7(b). For example, in the component pane, components necessary for creating a catalog, such as “VM,” “NIC,” “Volume,” and “Flavour,” are automatically generated. A component is arranged from the component pane to the editor pane by dragging and dropping the component, and connection is performed between connectors by dragging and dropping them. A plurality of NICs/Volumes/Flavours can be connected to one VM. Connector constraints are also automatically generated. In the parameter input pane, basic information that can be input when a component is not selected is displayed, and component information (VM information, NIC information, Volume information, or the like) that can be input when each component is selected is displayed.

FIG. 8 is a diagram illustrating a correspondence relationship between a catalog definition file F1 and a GUI in the embodiment of the present invention. As illustrated in FIG. 8, a catalog ID, basic information, and configuration components are described in the catalog definition file F1, and an information setting of each component is described in a component definition file F2. The information setting of each component may also be described in the catalog definition file F1 (the component definition file F2 can be regarded as a part of the catalog definition file F1).

As illustrated in FIG. 8, a catalog ID, a catalog name, basic information, a configuration component, and the like are described in the catalog definition file F1. A component ID, a component name, a component configuration item list, and the like are described in the component definition file F2. A specific catalog definition/component definition or a setting example will be described below.

IF Definition Method

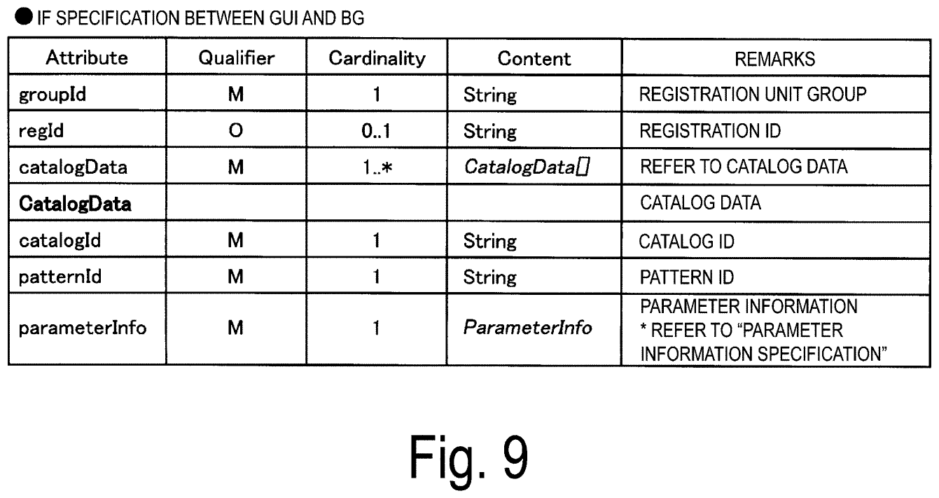

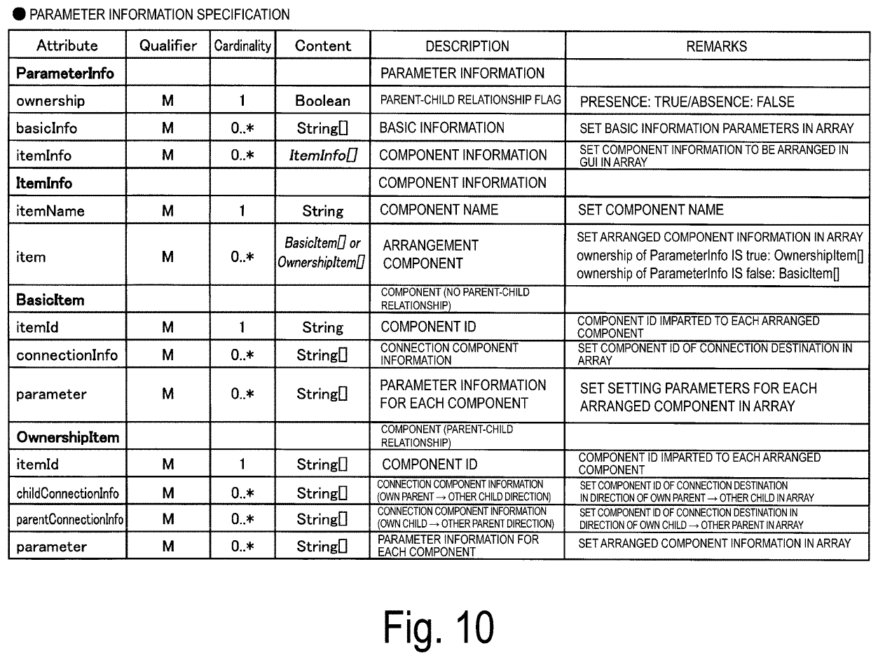

FIGS. 9 and 10 are diagrams illustrating an IF definition method between the GUI generation device 30 and the catalog creation device 40 in the embodiment of the present invention. Specifically, FIG. 9 illustrates an IF specification between the GUI generation device 30 and the catalog creation device 40, and FIG. 10 illustrates a parameter information specification. A meaning of each item is as described in a description field and a remark field. As illustrated in FIGS. 9 and 10, content of the catalog is abstracted in a service-independent manner for a general-purpose IF.

Method of Generalizing Catalog Creation Functional Unit

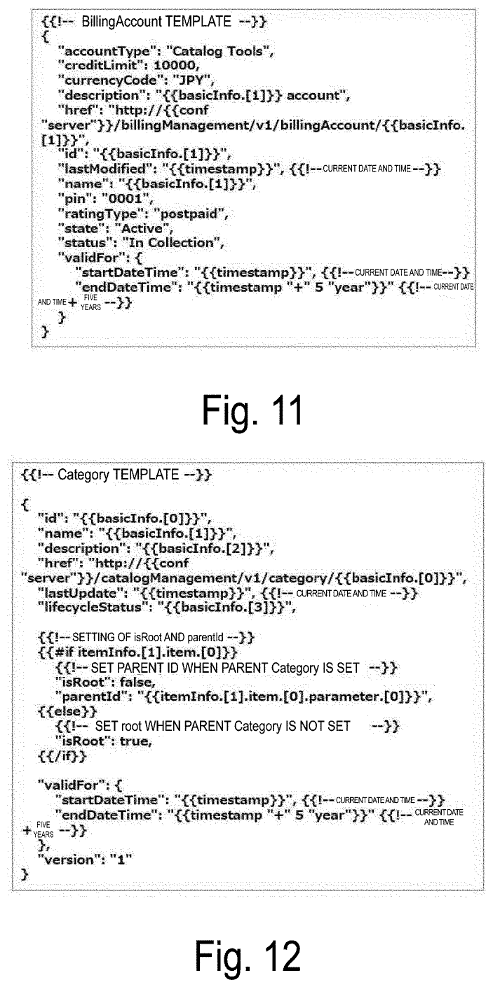

FIGS. 11 and 12 are diagrams illustrating a method of generalizing the catalog creation functional unit 45 in the embodiment of the present invention. Specifically, FIG. 11 illustrates an example of a template of BillingAccount defined in a telemanagement forum (TM Forum), and FIG. 12 illustrates an example of a template of Category. It is possible to generalize the catalog creation functional unit 45 by defining a template of the catalog according to the IF (FIGS. 9 and 10), as illustrated in FIGS. 11 and 12. Specifically, it is possible to define a template that is independent of a service type of the catalog by expressing a variable value using only basicInfo and itemInfo, as defined in FIGS. 9 and 10.

Method of Cooperating with Other System

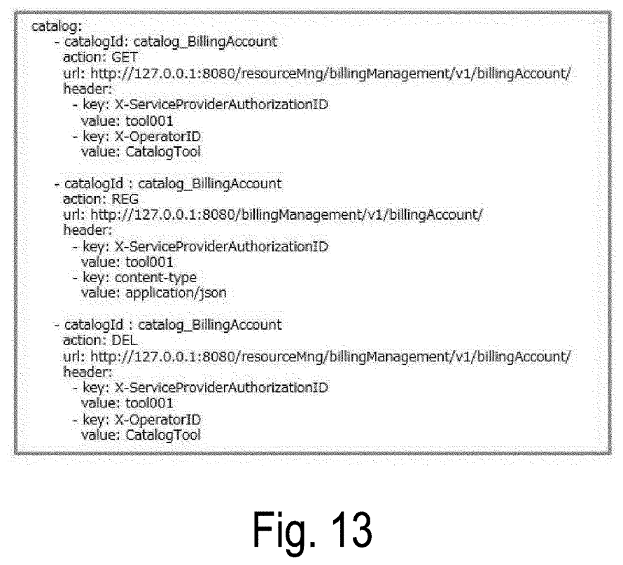

FIG. 13 is a diagram illustrating a setting of the other-system cooperative functional unit 43 in the embodiment of the present invention. As illustrated in FIG. 13, it is possible to realize the cooperation with the other system 50 by setting a catalog Id and information on a cooperation destination system as the setting of the other-system cooperative functional unit 43. Specifically, cooperation destination system information of a REST API is described for the catalog Id according to the IF defined in FIGS. 9 and 10, thereby realizing the cooperation with the other system 50.

### Operation Example

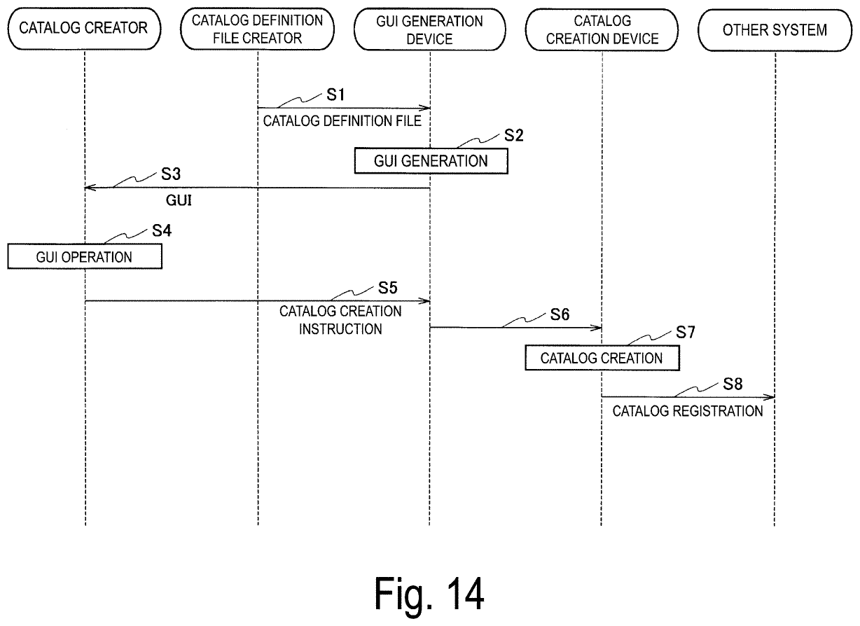

FIG. 14 is a sequence diagram illustrating basic operation of the catalog creation support system in the embodiment of the present invention. Hereinafter, a general flow when cooperation with the other system 50 is performed will be described.

First, it is assumed that the catalog definition file creator 20 is creating the catalog definition file F1 (step S1). The GUI generation device 30 provides a GUI in response to a request from the catalog creator 10 (step S2→S3). When the catalog creator 10 operates the GUI and clicks catalog creation in the GUI, a catalog creation instruction signal is sent from the GUI generation device 30 to the catalog creation device 40 (step S4→S5→S6). Thus, the catalog creation device 40 generates a catalog using the template, and registers the generated catalog in the other system 50 (step S7→S8).

Catalog Definition Specification and Component Definition Specification

Hereinafter, specific catalog definitions/component definitions will be described. Of course, catalog definitions/component definitions to be described below are merely examples, and the present invention is not limited thereto.

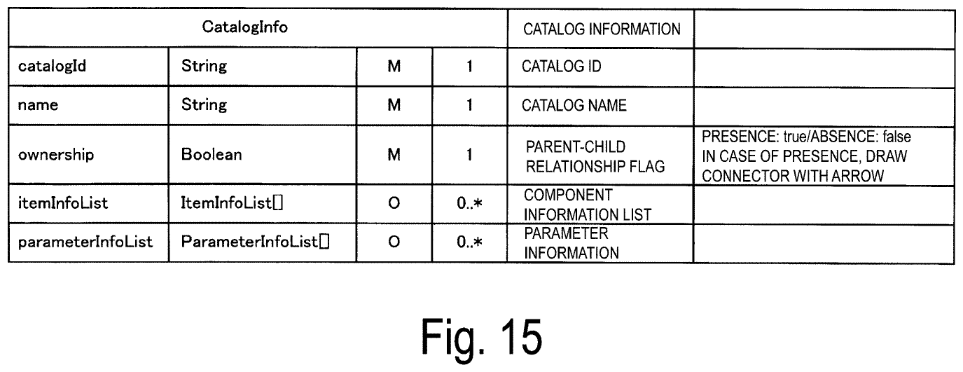

FIG. 15 is a diagram illustrating a setting example of catalog information in the embodiment of the present invention. As illustrated in FIG. 15, a catalog ID, a catalog name, a parent-child relationship flag, a component information list, and parameter information may be set. In the parent-child relationship flag, presence (true) or absence (false) is set, and in the case of presence, a connector is drawn with an arrow.

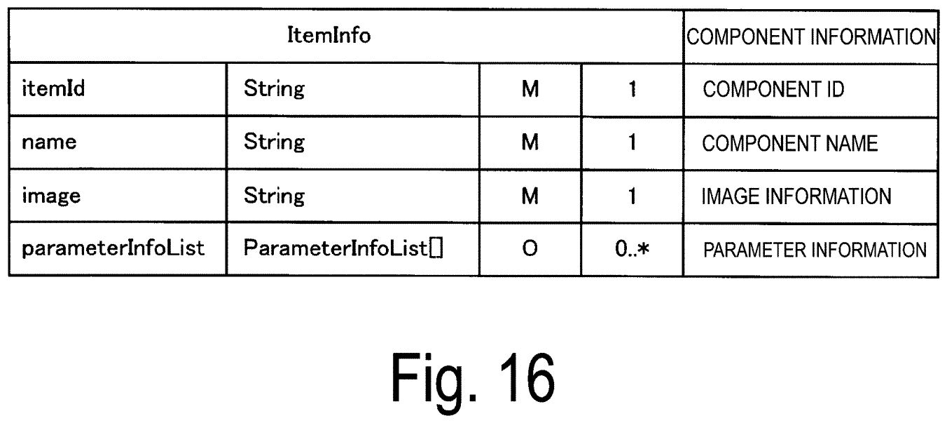

FIG. 16 is a diagram illustrating a setting example of component information in the embodiment of the present invention. As illustrated in FIG. 16, a component ID, a component name, image information, and parameter information may be set.

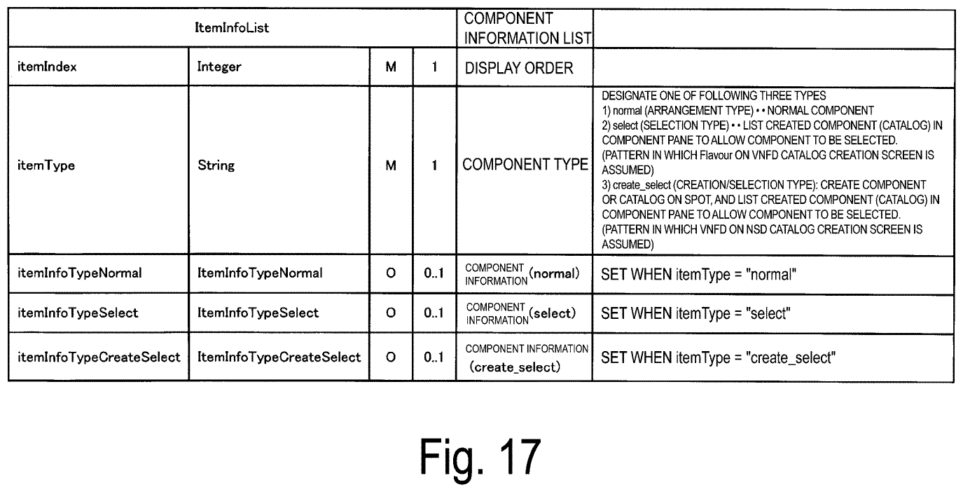

FIG. 17 is a diagram illustrating a setting example of a component information list in the embodiment of the present invention. As illustrated in FIG. 17, a display order, a component type, component information (normal), component information (select), and component information (create_select) may be set. For the component type, one of three types of normal (arrangement type), select (selection type), and create_select (creation and selection type) is designated. Normal (arrangement type) is designated when a component is a normal component. Select (selection type) is designated when created components (catalog) are listed in the component pane and selected. In other words, this is a pattern in which Flavour of a VNFD catalog creation screen is assumed. create_select (creation and selection type) is designated when a component or catalog is created on the spot and the created component (catalog) is listed in the component pane and selected. In other words, this is a pattern in which VNFD on an NSD catalog creation screen is assumed. The component information (normal) is set when itemType=“normal.” The component information (select) is set when itemType=“select.” The component information (create_select) is set when itemType=“create_select.”

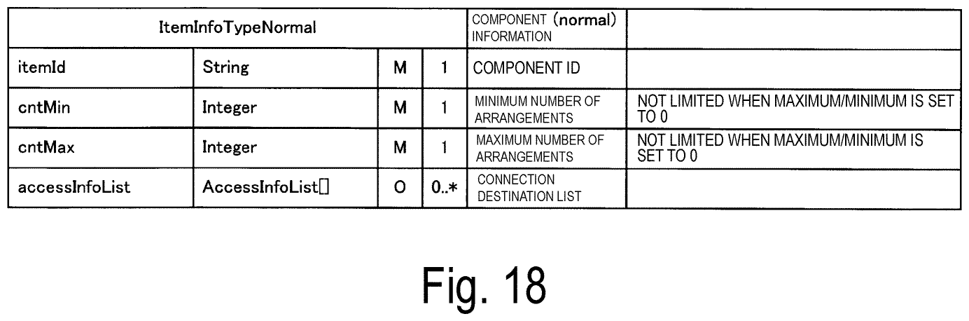

FIG. 18 is a diagram illustrating a setting example of component information (normal) in the embodiment of the present invention. As illustrated in FIG. 18, a component ID, a minimum number of arrangements, a maximum number of arrangements, and a connection destination list may be set. There is no limitation in a case in which 0 is set as the minimum number of arrangements and the maximum number of arrangements.

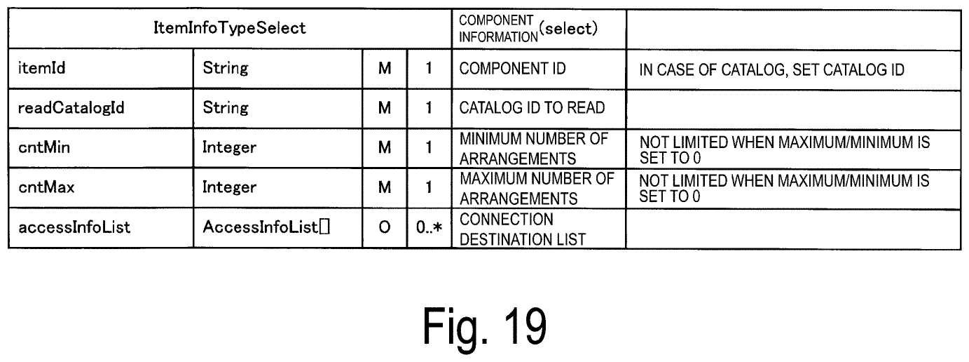

FIG. 19 is a diagram illustrating a setting example of component information (select) in the embodiment of the present invention. As illustrated in FIG. 19, a component ID, a catalog ID to be read, a minimum number of arrangements, a maximum number of arrangements, and a connection destination list may be set. For the component ID, a catalog ID is set in the case of a catalog. There is no limitation in a case in which 0 is set as the minimum number of arrangements and the maximum number of arrangements.

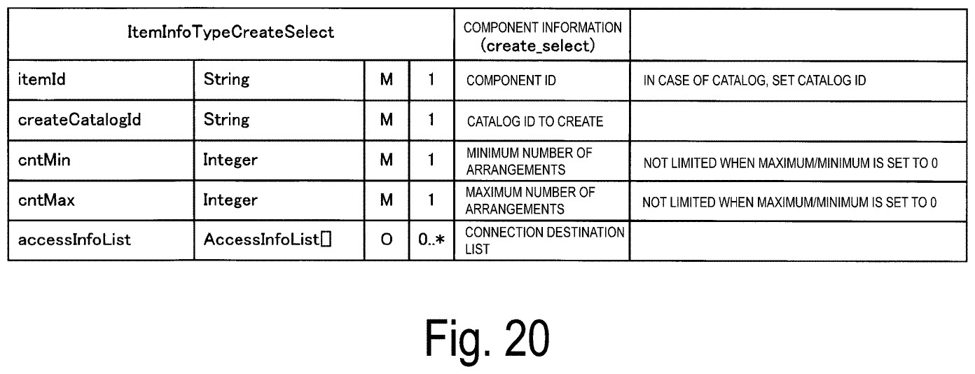

FIG. 20 is a diagram illustrating a setting example of component information (create_select) in the embodiment of the present invention. As illustrated in FIG. 20, a component ID, a catalog ID to be created, a minimum number of arrangements, a maximum number of arrangements, and a connection destination list may be set. For the component ID, a catalog ID is set in the case of a catalog. There is no limitation in a case in which 0 is set as the minimum number of arrangements and the maximum number of arrangements.

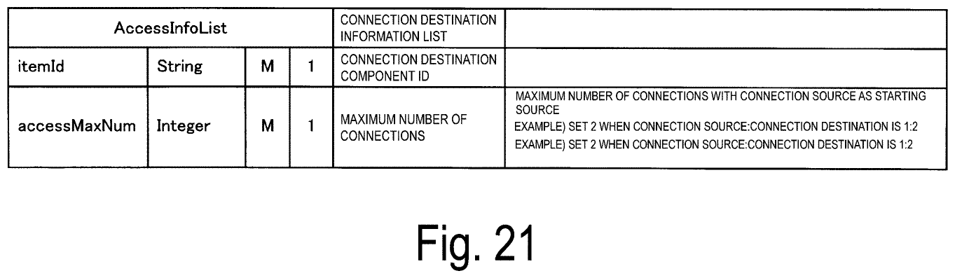

FIG. 21 is a diagram illustrating a setting example of a connection destination information list in the embodiment of the present invention. As illustrated in FIG. 21, a connection destination component ID and a maximum number of connections may be set. For the maximum number of connections, a maximum number of connections with a connection source as a starting point is set. For example, when a connection destination is “1:2,” 2 is set as the connection source. Further, when the connection destination is “1:limitless,” 0 is set as the connection source.

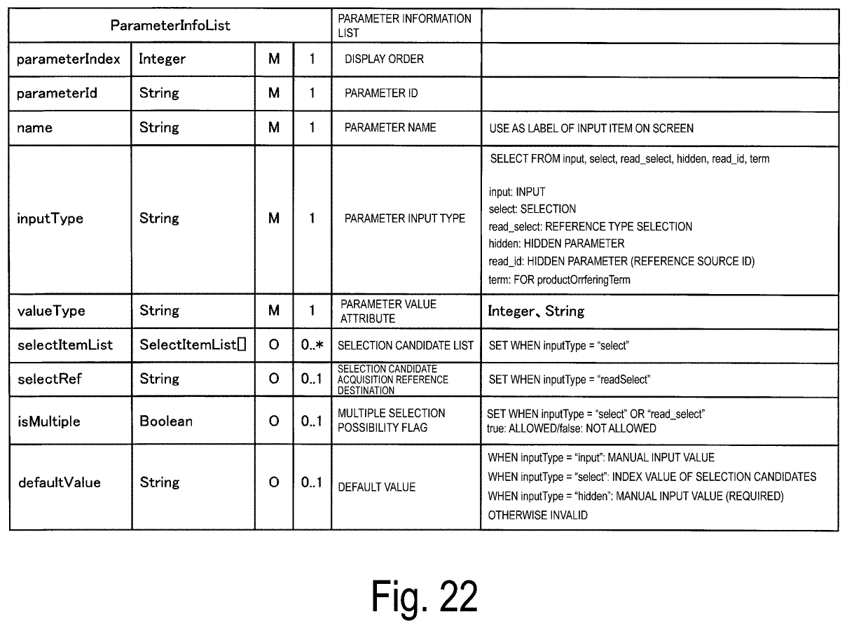

FIG. 22 is a diagram illustrating a setting example of a parameter information list in the embodiment of the present invention. As illustrated in FIG. 22, a display order, a parameter ID, a parameter name, a parameter input type, a parameter value attribute, a selection candidate list, a selection candidate acquisition reference destination, a multiple selection possibility flag, and a default value may be set. The parameter name is used as a label for input items on a screen. The parameter input type is selected from input, select, read_select, hidden, read_id, and term. Input means input, Select means selection, read_select means reference type selection, hidden means hidden parameter, read_id means hidden parameter (reference source ID), and term means productOrrferingTerm. Integer and String are set as the parameter value attributes. The selection candidate list is set when inputType=“select.” The selection candidate acquisition reference destination is set when inputType=“readSelect.” The multiple selection possibility flag is set when inputType=“select” or “read_select.” default value is a manual input value when inputType=“input,” an index value of selection candidates when inputType=“select,” and a manual input value (required) when inputType=“hidden,” and otherwise is invalid.

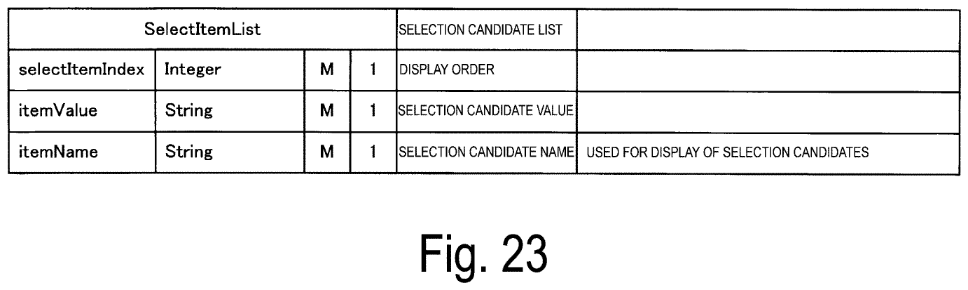

FIG. 23 is a diagram illustrating a setting example of the selection candidate list in the embodiment of the present invention. As illustrated in FIG. 23, a display order, a selection candidate value, and a selection candidate name may be set. The selection candidate name is used for a display of the selection candidates.

### Setting Example

A specific example of setting the catalog definitions/component definitions will be described below. Of course, setting examples to be described below are merely examples, and the present invention is not limited thereto.

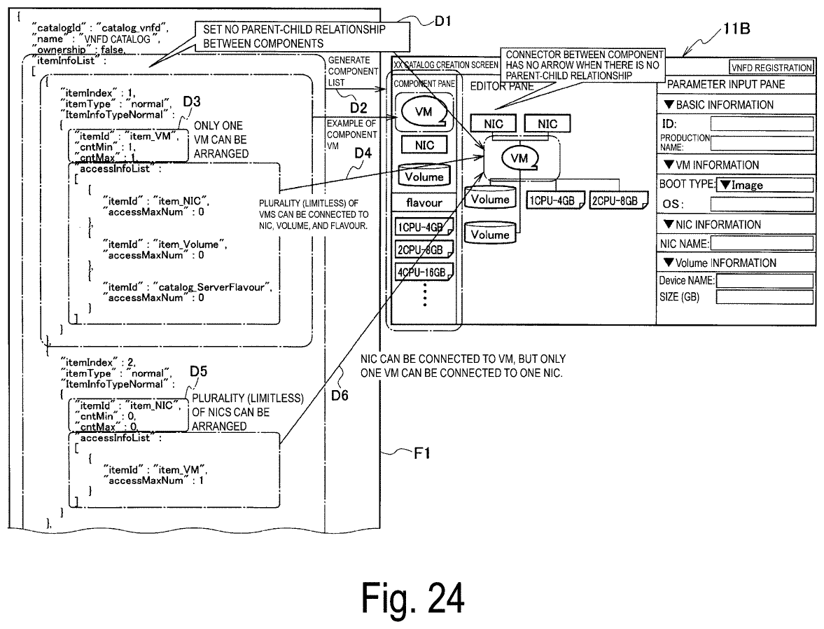

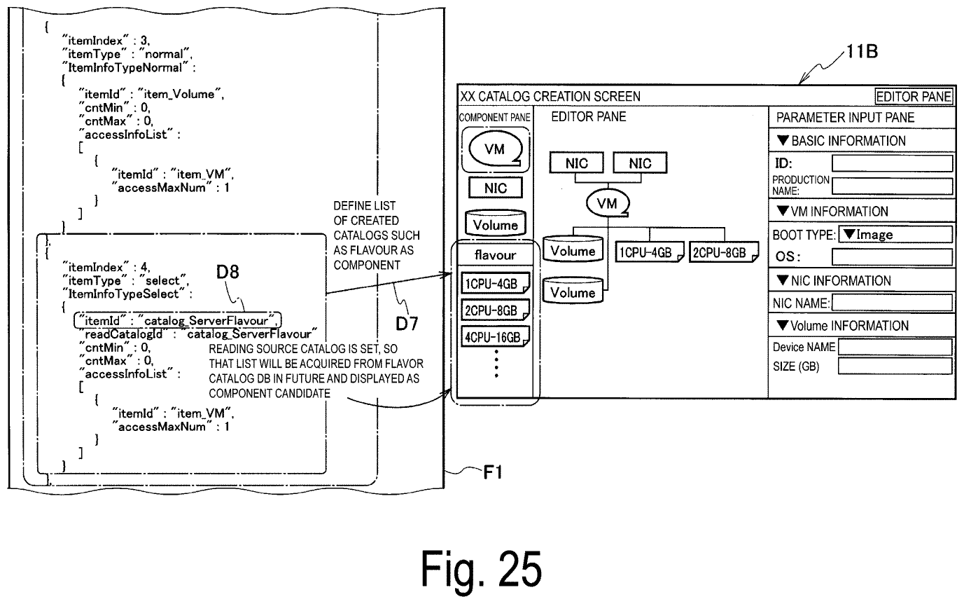

FIGS. 24 to 26 are diagrams illustrating a setting example of the catalog definition (CatalogInfo) using the VNFD catalog creation screen 11B as an example. Here, content of one catalog definition file F1 is described over three figures of FIGS. 24 to 26 due to space limitations.

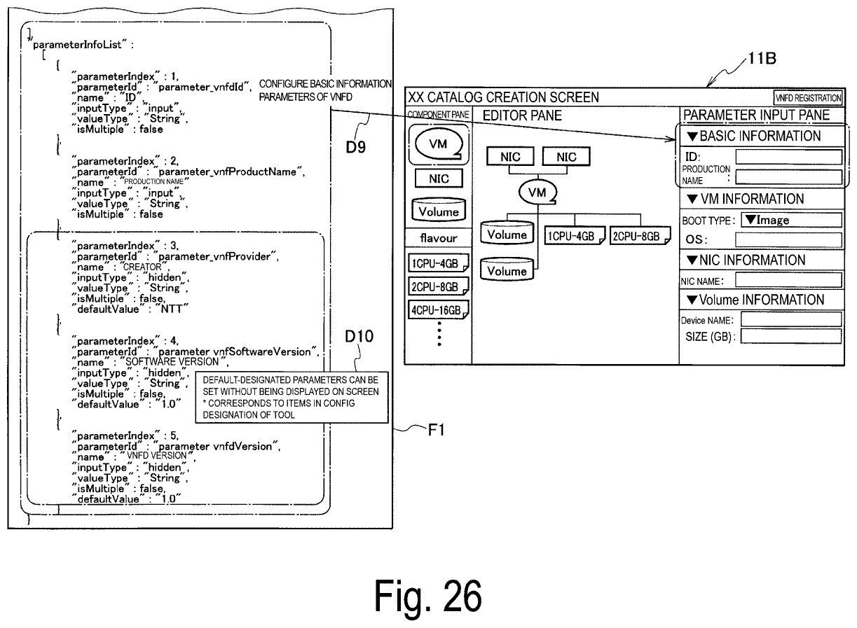

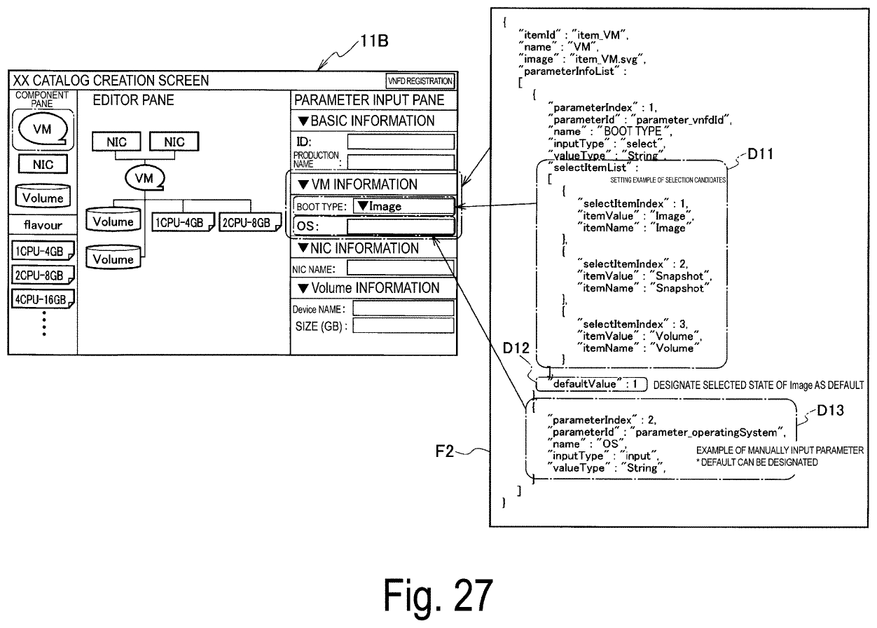

First, there being no parent-child relationship between the components is set in the catalog definition file F1 (see reference sign D1), as illustrated in FIG. 24. When there is no parent-child relationship, connectors between components in the editor pane have no arrows. In a part denoted by reference sign D2, a component list is generated. In itemIndex “1,” only one VM can be arranged (see reference sign D3), and a plurality of (limitless) VMs can be connected to each of NIC, Volume, and Flavour (see reference sign D4). In itemIndex “2,” a plurality of (limitless) NICs can be arranged (see reference sign D5) and the NIC can be connected to the VM, but only one VM can be connected to one NIC (see reference sign D6). Further, as illustrated in FIG. 25, a list of created catalogs such as Flavour is also defined as a component (see reference sign D7). A reading source catalog is set, so that a list will be acquired from a flavour catalog DB in the future and displayed as a component candidate (see reference sign D8). Further, as illustrated in FIG. 26, a part denoted by reference sign D9 constitutes a basic information parameter of VNFD. Default-designated parameters can be set without being displayed on the screen (see reference sign D10).

FIG. 27 is a diagram illustrating a setting example of a component definition (ItemInfo) using the VNFD catalog creation screen 11B as an example. A part denoted by reference sign D11 is a setting example of selection candidates. A selected state of an image is designated as a default (see reference sign D12). A part denoted by reference sign D13 is an example of a manually input parameter (default designation is also possible).

As described above, the catalog creation support system in the embodiment of the present invention is a system that supports catalog creation used in an orchestrator, and includes a GUI generation device 30 that generates a GUI, and the catalog creation device 40 that creates a catalog, and the catalog definition file F1 in which the definition information of the catalog has been described is read, and a service-independent catalog information abstraction model is constructed. Thus, the catalog creator 10 can intuitively create a catalog with the GUI using the service-independent catalog information abstraction model.

Specifically, the GUI including the component pane, the editor pane, and the parameter input pane is generated. That is, it is possible to generate a GUI without depending on the catalog configuration by decomposing description content of the catalog to be created into configuration components, relationships between components, and parameter settings and creating a definition file.

Further, it is possible to define a template that is independent of a service type of the catalog. Further, an interface is abstracted so that the variables described in the template are treated as “array value of basic information” or “array value of component information” together with the catalog definition on the GUI. This enables generation of a characteristic catalog to be realized.

Further, the content of the catalog is abstracted in a service-independent manner as a general-purpose interface. This enables a characteristic interface to be realized.

Further, the output catalog is linked with the orchestrator (other system 50) by an API. This makes it possible to realize cooperation with the other system 50.

The present invention can be realized not only as such a catalog creation support system, but also as a catalog creation support method in which characteristic functional units included in such a catalog creation support system are steps, or can be realized as a program for causing a computer to execute these steps. Such a program can be distributed via a recording medium such as a CD-ROM or a transmission medium such as the Internet.

### REFERENCE SIGNS LIST

10 Catalog creator
20 Catalog definition file creator
30 GUI generation device
31 Web server functional unit
32 GUI generation functional unit
33 BG cooperative functional unit
34 Catalog information temporary storage functional unit
35 GUI resource management functional unit
36 Catalog definition information management functional unit
40 Catalog creation device
41 BG control functional unit
42 GUI cooperative functional unit
43 Other-system cooperative functional unit
44 Catalog information management functional unit
45 Catalog creation functional unit
46 Catalog template management functional unit
50 Other system (orchestrator)
F1 Catalog definition file

1. A catalog creation support system for supporting catalog creation used in an orchestrator, the catalog creation support system comprising:
a GUI generation device configured to generate a GUI; and
a catalog creation device configured to create a catalog,
wherein the catalog creation support system is configured to read a catalog definition file in which definition information of the catalog is described and to construct a service-independent catalog information abstraction model.

2. The catalog creation support system according to claim 1, wherein the GUI includes a component pane, an editor pane, and a parameter input pane.

3. The catalog creation support system according to claim 1,
wherein the catalog creation support system is configured to define a template that is independent of a service type of the catalog, and
the catalog creation support system is configured to abstract an interface so that variables described in the template are treated as “array value of basic information” or “array value of component information” together with a catalog definition on a GUI.

4. The catalog creation support system according to claim 1, wherein content of the catalog is abstracted in a service-independent manner as a general-purpose interface.

5. The catalog creation support system according to claim 1, wherein an output catalog is linked with the orchestrator by an API.

6. A catalog creation support method for supporting catalog creation used in an orchestrator, the catalog creation support method comprising:
generating, at a GUI generation device, a GUI; and
creating, at a catalog creation device, a catalog,
wherein a catalog definition file in which definition information of the catalog is described is read and a service-independent catalog information abstraction model is constructed.

7. A non-transitory computer readable medium storing one or more instructions for causing a computer to execute:
generating, at a GUI generation device, a GUI; and
creating, at a catalog creation device, a catalog,
wherein a catalog definition file in which definition information of the catalog is described is read and a service-independent catalog information abstraction model is constructed.

8. The catalog creation support method according to claim 6, wherein the GUI includes a component pane, an editor pane, and a parameter input pane.

9. The catalog creation support method according to claim 6, further comprising:
defining a template that is independent of a service type of the catalog; and
abstracting an interface so that variables described in the template are treated as “array value of basic information” or “array value of component information” together with a catalog definition on a GUI.

10. The catalog creation support method according to claim 6, further comprising abstracting content of the catalog in a service-independent manner as a general-purpose interface.

11. The catalog creation support method according to claim 6, further comprising linking an output catalog with the orchestrator by an API.

12. The non-transitory computer readable medium according to claim 7, wherein the GUI includes a component pane, an editor pane, and a parameter input pane.

13. The non-transitory computer readable medium according to claim 7, wherein the one or more instructions further cause the computer to execute:
defining a template that is independent of a service type of the catalog; and
abstracting an interface so that variables described in the template are treated as “array value of basic information” or “array value of component information” together with a catalog definition on a GUI.

14. The non-transitory computer readable medium according to claim 7, wherein the one or more instructions further cause the computer to execute:
abstracting content of the catalog in a service-independent manner as a general-purpose interface.

15. The non-transitory computer readable medium according to claim 7, wherein the one or more instructions further cause the computer to execute:
linking an output catalog with the orchestrator by an API.
